(19) United States
(12) Patent Application Publication
(10) Pub. No.: US 2005/0071215 A1
(43) Pub. Date: Mar. 31, 2005

(54) Process and apparatus for generating a product-specific statistical inventory buffer

(76) Inventors: Chris A. Armbruster, Allentown, PA (US); Jeffry E. Moore, Kempton, PA (US); Simon D. Powell, Bethlehem, PA (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/675,242

(22) Filed: Sep. 30, 2003

(51) Int. Cl. G06F 17/60

(52) U.S. Cl. 705/10

(57) ABSTRACT

A method for determining a product inventory buffer. An anticipated product demand is estimated by a buyer at the start of a time period and the realized demand is determined at the end of the time period. A relationship is determined between the anticipated and the realized demand over a plurality of time periods and statistically analyzed to determine the inventory buffer for a target shipping confidence.

### FIELD OF THE INVENTION

The present invention relates generally to forecasting and inventory control, and more particularly relates to a process and apparatus for generating a product-specific inventory buffer.

### BACKGROUND OF THE INVENTION

Demand forecasting is generally concerned with predicting future customer demand for one or more products produced in a manufacturing facility. In the most simplistic case, knowledgeable individuals, including for instance sales representatives, can prepare a demand forecast, making projections of future demand based on experience, information received from customers and general economic conditions. Alternatively, future demand can be predicted by analyzing and applying statistical analysis techniques to historical shipment data. Typically, the future demand is based on a historical time window and the forecast is produced for a future lead-time, for example, four months from the present.

It is known that all demand forecast processes can produce a forecast error, resulting in poor inventory performance (i.e., excess inventory) or poor shipping performance (i.e., inability to meet the customer's shipping requirements due to an inventory shortage). The forecast error probability and the magnitude of the error is especially acute in certain industries such as those having an intermittent demand (periods of zero demand followed by periods of high demand), those in which the product has a limited lifecycle (e.g., fashion products) and those for which the consumer demand is erratic.

Given the vagaries of the high technology market, including the continual development of new products and the resulting accelerated obsolescence of old products, demand forecasting is challenging for semiconductor integrated circuit manufacturers supplying components for these products. Demand forecasting is further complicated by the large number of different products (also referred to as codes) manufactured by most integrated circuit manufacturers. Generally, demand for one specific integrated circuit is not related to the demand for other integrated circuits.

These market forces may make it difficult for integrated circuit buyers to accurately predict demand, making it difficult for manufacturers to achieve a high level of shipping performance without negatively impacting inventory performance. To avoid an inventory shortfall the manufacturer may fabricate more product than the expected demand, holding the excess in inventory. Although avoiding poor shipping performance, there is the excess inventory cost to be considered.

The ability to accurately and timely predict customer demand is critical to the operation of a successful business. Accurate forecasting leads to accurate inventory control, limiting the carrying charges of excess inventory while ensuring a sufficient inventory to satisfy the customer's demand. Maintaining the right amount of inventory in the face of changing customer demands ensures a successful business.

Inventory buffeting is one process employed by manufacturers to ensure an adequate inventory. The buffer provides an inventory margin for a product so that demand uncertainties within a typical range can be accommodated. The inventory buffer size is usually determined using a “one size fits all” approach, where all manufactured products are considered and treated identically. According to the prior art, the buffer size is determined based on the manufacturer's high-level business objectives (e.g., the amount of demand the manufacturer wants to be able to satisfy), the aggregate data for a large number of products or from the peak demand based on a worst-case historical scenario.

The above approach wherein a single inventory buffer size is applied to all products does not account for the unique demand profile or behavior of each product. Thus, according to this technique, certain products can experience an excess inventory situation while others can experience an inventory shortfall. Applying a single buffer target to all products generally results in sub-optimum performance for all products. For some products the buffer target is too large, causing excess inventory and the expense of supporting the excess inventory. When the buffer is too small, shipping performance is affected, as the customer's demand cannot be satisfied.

A peak detection process using a worst-case historical demand target is also not optimum, as no consideration is given to the re-occurrence probability for the worst-case demand. The inventory performance suffers (i.e., the manufacturer carries an excess inventor) when the worst case does not reappear during the forecast period.

### BRIEF SUMMARY OF THE INVENTION

The present invention comprises a method for determining an inventory buffer for use by a seller of products to a buyer. A demand sample interval is selected and the buyer's anticipated demand and the buyer's realized demand are determined for a plurality of the sample intervals. A plurality of demand change values are determined from each one of the like plurality of anticipated demand and realized demand value pairs. The plurality of demand change values are modeled as a probability distribution function and statistical parameters determined for the probability distribution function. The inventory buffer is determined from the statistical parameters.

### BRIEF DESCRIPTION OF THE DRAWINGS

The foregoing and other features of the present invention will be apparent from the following more particular description of the invention as illustrated in the accompanying drawings, in which like reference characters refer to the same parts throughout the different figures. The drawings are not necessarily to scale, emphasis instead being placed upon illustrating the principles of the invention.

FIGS. 1-6 depict various demand graphs for determining the inventory buffer according to the teachings of the present invention.

### DETAILED DESCRIPTION OF THE INVENTION

Before describing in detail the particular demand forecasting process and apparatus in accordance with the present invention, it should be observed that the present invention resides in a novel and non-obvious combination of method steps and elements. Accordingly, these method steps and elements have been represented by conventional items in the drawings, showing only those specific details that are pertinent to the present invention so as not to obscure the disclosure with details that will be readily apparent to those skilled in the art having the benefit of the description herein.

In developing an inventory control technique to satisfy a customer's future demand, the customer's past orders may not be a reliable indicator of its future demand. However, a customer's past certainty about its forward looking demand can be a good indicator of the present certainty of its future demand. The demand certainty can be statistically profiled and used to create an inventory buffer for the product, where the buffer represents an amount of excess inventory to be kept on hand that should satisfy the customer's expected future demand. The demand statistics used to create the inventory buffer can be product specific, avoiding the one-size-fits-all simplification of the prior art. As applied to the semiconductor integrated circuit fabrication industry, the buffer is product code specific, wherein each integrated circuit is identified by a unique product code.

In the following description of the present invention, an anticipated demand represents the quantity of goods or services that are expected to be shipped or provided during a predetermined future time horizon to a buyer by a seller. A realized demand represents the actual quantity of shipped items or services provided by the seller to the buyer over the same time horizon. A change in demand is a difference between the realized demand and the anticipated demand. A positive change in demand is referred to as an upside and a negative change is referred to as a downside. Upsides represent an inventory shortfall because the realized demand exceeded the anticipated demand. Downsides represent an inventory excess because the realized demand was less than the anticipated demand. Thus the seller was able to meet the realized demand.

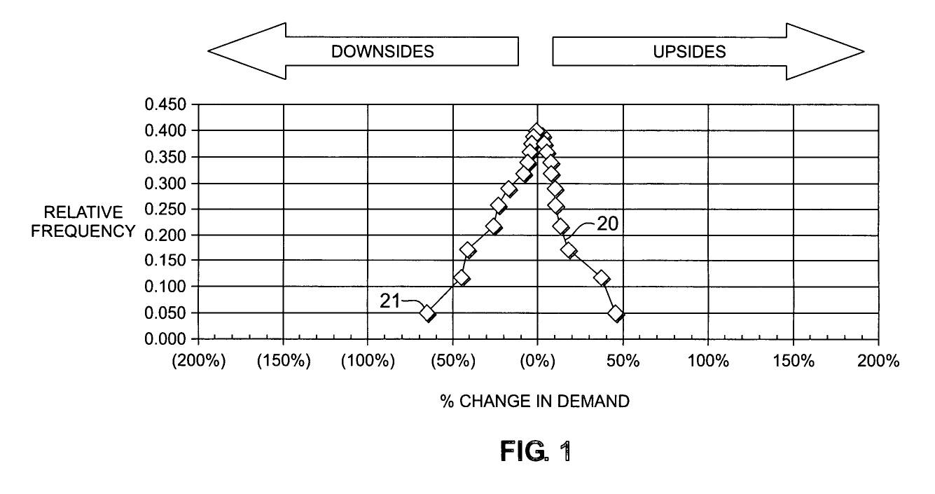

The first step in a method according to the teachings of the present invention is the generation of a change in demand plot as illustrated in FIG. 1. The percent change in demand is plotted on the x-axis and the relative frequency of the change in demand occurrences is plotted on the y-axis. Larger values on the y-axis indicate a high relative frequency of occurrence and values toward the origin indicate a low relative frequency of occurrence for the corresponding change in demand value plotted on the x-axis. Upside changes in demand are those to the right of zero percent and downside changes in demand are graphed to the left of the zero percent point. A zero percent demand change indicates that the anticipated demand and the realized demand were identical.

FIG. 1 plots a 26 week time horizon during which the certainty of demand is sampled on a weekly basis, that is the anticipated demand and the realized demand are determined weekly for 26 weeks. Both the 26 week time horizon and the weekly sampling frequency are merely exemplary. A longer or shorter time horizon and more frequent or less frequent sampling can be used depending on the industry and product to which the teachings are applied. The time horizon (i.e., the number of sample points) should be selected so that historically relevant demands are included in the buffer calculation, while those that are too remote in time so as to not significantly affect future demand are not considered. The sampling frequency can be selected based on the number of inventory points available in the supply chain. For example, assume a product manufacturing process includes two distinct sub-processes. The first sub-process includes a first plurality of steps for manufacturing a semi-finished product, followed by a second sub-process including a second plurality of steps to complete the product. It may be advisable to use a first sampling period equal to the duration of the first plurality of steps and a second sampling period equal to the duration of the second plurality of steps. Thus an inventory buffer can be calculated for each of the two sub-processes. A first inventory buffer determines the inventory of semi-finished products and a second inventory buffer determines the inventory of finished products.

Each graph data point (depicted by a square in FIG. 1) represents the change in demand over a one week time period. In this embodiment, a 26 week time horizon is used to construct FIG. 1, thus the graph includes 26 sample points, each sample point representing the demand change for one week. At the beginning of week 1 the buyer provides an anticipated demand for week 1. At the end of week 1, the seller compares the buyer's anticipated demand with the realized demand for week 1. The percent demand graphed is the realized demand less the anticipated demand, with the result divided by the anticipated demand. For example, if the anticipated demand for the week was 600 units and the realized demand for the week was 400 units, then the demand change is −25% or a 25% downside: (450−600)/600=−0.25.

The process according to the present invention employs a roiling time horizon for computing the percent demand change and the inventory buffer based on the demand change. In one embodiment, the process rolls forward on a weekly basis. Thus the exemplary 26 week comparison time horizon moves forward one week each week adding the most current week to the comparison and removing the week furthest from the current week. For example, at the end of 26 weeks, 26 weekly data points are available to determine the inventory buffer as described herein. At the end of the 27^{th} week, the data for week 26 is removed and the data for week 27 added. The 26 week time horizon is retained, but the horizon includes demand data for only the most recent 26 weeks.

Using a weekly sampling interval and a 26 week time horizon, the weekly percentage demand changes are graphed in FIG. 1, resulting in a curve 20. Note that the curve 20 bears some resemblance to a normal distribution curve. A point 21 on the curve 20 indicates that a 55% demand change occurs in 5% of the plotted demand change values.

The use of weekly demand values and a 26 week time horizon are merely exemplary, as in other embodiments different time periods can be used. For example, in other embodiments the anticipated demand and the realized demand are determined every two weeks or every six weeks. In the case of a six week demand interval, assume the buyer's anticipated demand was 1000 units per week (a total of 6000 units) for the six week period. At the end of the six week period the seller determines the weekly realized demand was: 500, 500, 500, 1000, 1000 and 1000. Thus the total realized demand was 4500 units. The demand change is a 25% downside calculated as: (4500−6000)/6000=−25%. Both the six week and the two week periods can roll forward on a weekly basis to provide the rolling 26 week time horizon.

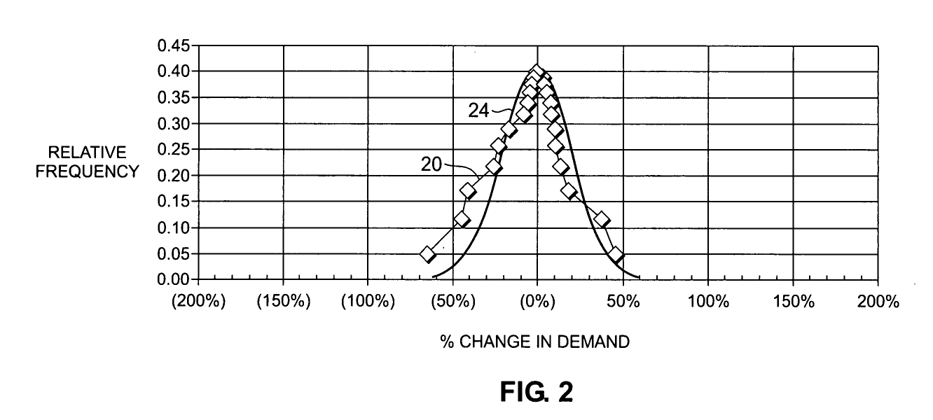

The FIG. 1 plot is then smoothed by known mathematical modeling techniques into a normal probability distribution function curve 24 illustrated in FIG. 2. In other embodiments of the present invention, other probability distribution functions can be used in lieu of the normal distribution. Generally, a probability distribution function that best fits the FIG. 1 demand profile can be selected. For example, in other embodiments a Rayleigh or an exponential distribution may be suggested by the demand profile. Since a normal distribution was chosen for the exemplary embodiment, normal probability distribution statistics will be used, as described below, according to this embodiment of the present invention.

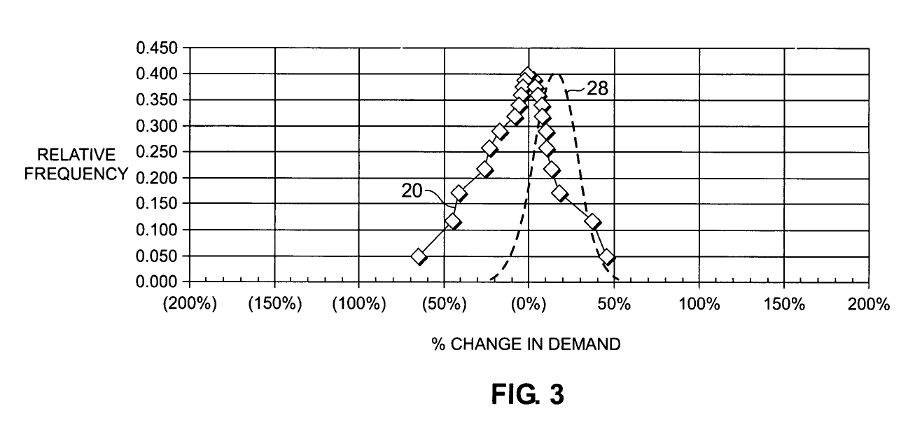

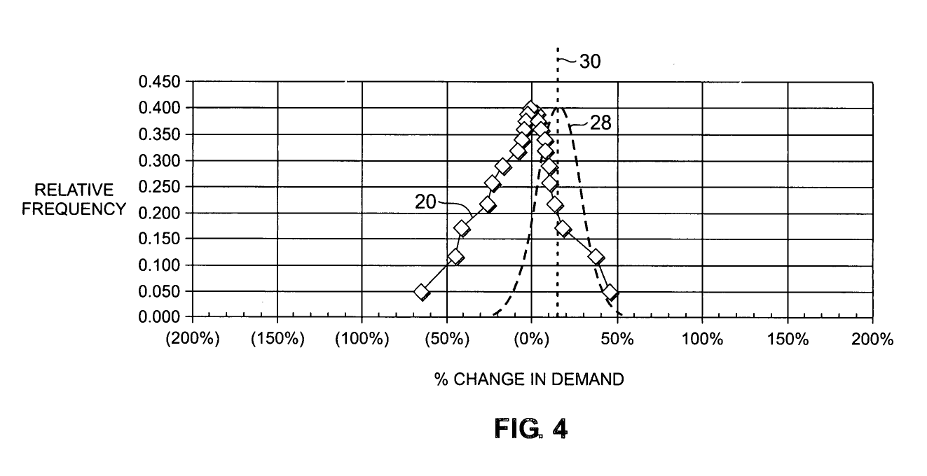

Since downside changes in demand do not create an inventory control problem (i.e., in a downside situation there was sufficient inventory to meet the buyer's demand) in one embodiment a normal distribution curve 28 for upside demand changes is generated. See FIG. 3. An upside demand bias or average 30 of the upside demand curve 28 is determined to be about 15% as illustrated in FIG. 4.

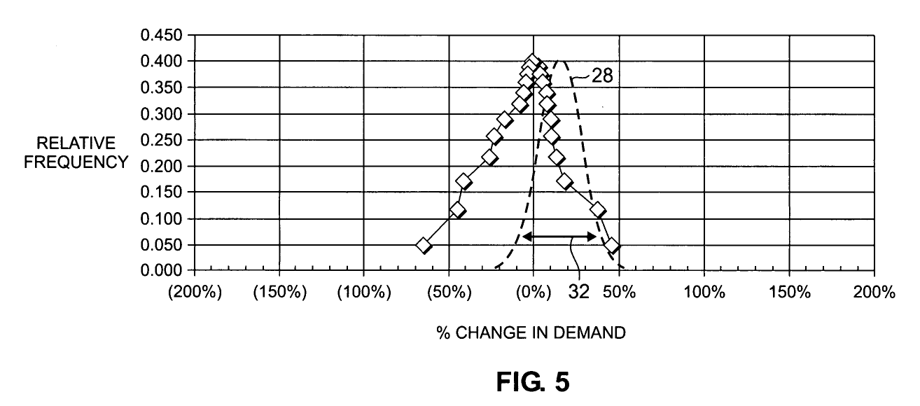

A demand variability is a measure of the distribution of the demand changes, also referred to as the standard deviation of the normal probability distribution function curve 28. Arrowheads 32 in FIG. 5 indicate the demand variability. A large or wide variability, i.e., a large standard deviation, indicates a high uncertainty of demand. A small or narrow variability indicates a low demand uncertainty. The variance of the curve 28 is determined to be about 25%. The standard deviation is the square root of the variance and thus about 5%. To create the inventory buffer according to the teachings of the present invention, normal distribution statistics are used to determine the buffer size required to satisfy the demand bias and the demand variability based on a target shipping performance.

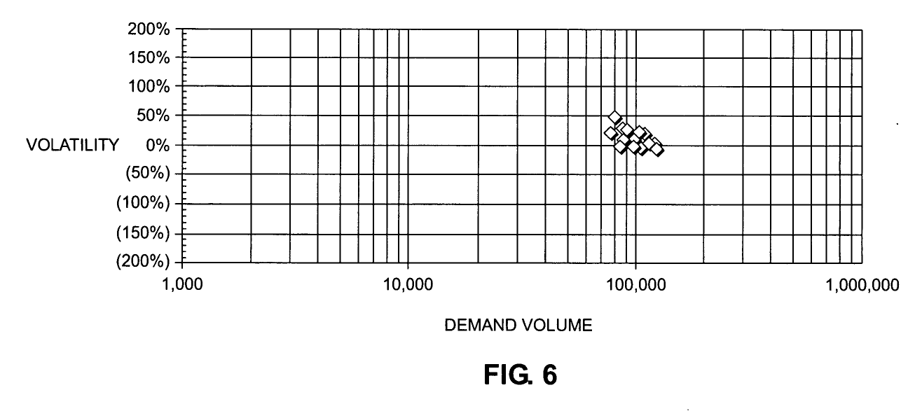

FIG. 6 illustrates the demand volume on the x-axis and the demand volatility on the y-axis. The demand volatility is defined as the standard deviation or demand variability 32 of FIG. 5 as a percentage of the anticipated demand. Thus the cluster of data points in FIG. 6 indicate the variability in the buyer's demand over the 26 week time horizon of the FIG. 1 graph.

Certain statistical measures can be ascertained from the various curves described above. A frequency of upside is a ratio of the number of upside demand changes to the total number of data points (i.e., the sum of the number of upside changes, the number of downside changes and the number of perfect demand forecasts, the latter where the demand variability is 0%).

In one embodiment, in lieu of calculating the upside average demand as a simple average for the upside demand curve 28 of FIG. 5, a demand volume-weighted upside average can be determined. Volume weighting, a technique known to those skilled in the art, weights each of the demand quantities as a ratio of the demand quantity to the sum of all the demand quantities for the period. The sum of the ratios is the demand volume weighted upside average. For the upside demand curve 28, using the demand volume numbers graphed in FIG. 6 as a percentage of the standard deviation, the upside volume weighted average is about 17.7%, compared with the unweighted or simple average of about 15%. Similarly, the volume-weighted standard deviation of the demand change is calculated to be about 9.7%, compared with the unweighted standard deviation of about 5%.

According to one embodiment of the present invention, an inventory buffer factor, from which the inventory buffer is calculated, is the sum of the upside volume-weighted average (17.7%) and the upside volume-weighted standard deviation (9.7%). The buffer factor is thus 27.4%. From this factor, the inventory buffer is determined as the product of the material buffer factor and the demand interval, which is one week in this example. Performing the multiplication yields an inventory buffer of 0.274 weeks, which can be rounded to 0.3 weeks. If the seller maintains a 0.3 week inventory buffer, it should be able to meet the buyer's demand for the product, when the buyer's demand is described by the statistical measures set forth above. The seller can convert the 0.3 week buffer into a buffer expressed as a number of product units by determining the number of products that it has shipped over a time period, for example one year or 52 weeks, and multiplying the number of shipped products by the ratio (0.3/52). The result is the inventory buffer expressed as a number of product units. For example, if the seller shipped 1,100,000 products during the last 52 weeks, for a material buffer of 0.3, it should retain an inventory of about 6,350 product units to meet the buyer's demands.

In another embodiment, a shipping confidence factor is included in the calculation of the inventory buffer factor. The confidence factor, expressed as a percentage, represents the percentage of the buyer's demand that the seller desires to satisfy. For example, the seller may select a 95% shipping confidence factor.

To calculate the material buffer factor in this embodiment, the downsides are removed from consideration since they represent sample points for which the buyer's anticipated demand was satisfied. For the FIG. 1 demand change graph, it has been determined that about 50% of the sample points are downsides or 0% demand change values, and 50% are upsides. For the selected 95% confidence factor, the inventory buffer must be sufficient to cover only 45% of the upside points (50% downsides+45% upsides=95%). Thus 90% of the 50% upsides must be covered by the inventory buffer. (90%×50%=45%). Using a normal distribution inverse calculation known in the art, it can be determined that for the upside normal distribution demand curve 28 (see FIG. 5), the 90% probability yields a z-factor or demand variability factor of 12%.

For the upside demand curve 28 of FIG. 5, recall that the upside volume weighted average is about 17.7%. The material buffer factor to achieve a 95% shipping confidence is the sum of the upside volume weighted average and the demand variability factor: 18% (the 17.7% value is rounded up to 18%)+12%=30%.

To determine the inventory buffer, the material buffer factor is multiplied by the applicable sample time interval (as used to create the percent demand change graph 20 of FIG. 1). Since the graph 20 uses a one week period, the inventory buffer is about 0.3 weeks. The number of product units represented by a 0.3 inventory buffer is determined from the product of (0.3/52) and the number of product units the seller shipped during the previous 52 weeks. Other shipment time periods can be used by changing the denominator to a value equal to the shipment time period expressed in weeks.

The teachings of the present invention are applicable to any industry where buyers purchase products from sellers over long time periods, during which the buyer's purchase requirements may change. Also, the time horizon for which the inventory buffer is calculated can be modified according to the manufacturing process of the seller.

The semiconductor fabrication process can be segregated into two components, the front-end process during which semiconductor wafers are processed to produce a plurality of semiconductor integrated circuits on each wafer, and a back-end process during which the wafers are singulated into individual integrated circuits (also referred to as die), tested, packaged and shipped. After the front-end process is complete, the wafers are stored in a die bank until they are required to fulfill a buyer's order, at which time they are released for back-end processing. Typically, a duration of the front-end process is about six weeks and the back-end process about two weeks.

The teachings of the present invention can be separately applied to each component of the semiconductor manufacturing process to determine a buffer inventory for each component. A six week time horizon is used for the front-end process and a two week time horizon for the back-end process. Since the demand statistics for the two time horizons are different, two inventory buffers can be determined. Thus as in the semiconductor manufacturing process, the teachings of the present invention can be applied to multiple steps of a supply chain process to provide more accurate inventory management controls for the seller.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope. It is intended that the invention not be limited to the particular embodiment disclosed as the best mode contemplated for carrying out the invention but that the invention will include all embodiments falling within the scope of the appended claims.

1. A method for determining an inventory buffer for use by a seller of products to a buyer, comprising:
(a) selecting a demand sample interval;
(b) determining the buyer's anticipated demand for the sample interval;
(c) determining the buyer's realized demand for the sample interval;
(d) repeating the steps (b) and (c) to generate a plurality of anticipated demand and realized demand value pairs;
(e) determining a plurality of demand change values from each one of the like plurality of anticipated demand and realized demand value pairs;
(f) modeling the plurality of demand change values as a probability distribution function;
(g) determining statistical parameters of the probability distribution function; and
(h) determining the inventory buffer from the statistical parameters.

2. The method of claim 1 wherein the statistical parameters comprise the mean and the standard deviation.

3. The method of claim 1 wherein an upside demand change value occurs when the realized demand is less than the anticipated demand, and wherein a downside demand change value occurs when the anticipated demand is less than the realized demand.

4. The method of claim 1 wherein the step (e) further comprises:
(e) determining a plurality of upside demand change values from the plurality of demand change values for which the realized demand is greater than the anticipated demand.

5. The method of claim 4 wherein the step (f) further comprises:
(f) modeling the plurality of upside demand change values as a probability distribution function.

6. The method of claim 1 wherein the probability distribution function comprises a normal probability distribution function.

7. The method of claim 1 wherein the step (b) is executed at a beginning of each sample interval.

8. The method of claim 1 wherein the step (c) is executed at an end of each sample interval.

9. The method of claim 1 wherein the sample interval is selected from among one week two weeks and six weeks.

10. The method of claim 1 wherein the plurality of anticipated demand and realized demand pairs of the step (d) comprises 26 anticipated demand and realized demand pairs.

11. The method of claim 1 wherein the step (h) further comprises:
(h1) determining a shipping confidence factor;
(h2) determining the inventory buffer from the shipping confidence factor and the statistical parameters.

12. The method of claim 1 wherein the step (e) further comprises:
(e1) determining a difference between the anticipated demand and the realized demand for each demand change value pair; and
(e2) determining a ratio of the difference and the anticipated demand, wherein the ratio comprises one of the plurality of demand change values.

13. The method of claim 1 wherein the step (f) further comprises modeling the plurality of demand change values as a probability distribution function with the plurality of demand change values plotted on an x-axis and a number representing the number of occurrences for each demand change value from among the plurality of demand change values plotted on the y-axis.

14. The method of claim 1 wherein the steps (b) and (c) are periodically executed over a predetermined time horizon, and wherein the step (e) further comprises determining a plurality of demand change values from each one of the like plurality of anticipated demand and realized demand value pairs on a rolling forward basis for the predetermined time horizon, such that an earliest in time one of the plurality of demand change values is discarded and replaced by a latest in time demand change value.

15. A method for determining an inventory buffer for use by a seller of products to a buyer, comprising:
(a) selecting a demand sample interval;
(b) determining the buyer's anticipated demand for the sample interval;
(c) determining the buyer's realized demand for the sample interval;
(d) repeating the steps (b) and (c) to generate a plurality of anticipated demand and realized demand value pairs;
(e) determining a plurality of upside demand change values from the plurality of anticipated demand and realized demand value pairs, wherein an upside demand change value comprises a demand change value for which the realized demand is greater than the anticipated demand;
(f) modeling the plurality of upside demand change values as a probability distribution function;
(g) determining the mean and the standard deviation of the probability density function;
(h) summing the mean and the standard deviation to determine an inventory buffer factor; and
(i) determining an inventory buffer as the product of the material buffer factor and the demand sample interval.

16. The method of claim 15 wherein the mean comprises a volume weighted mean.

17. The method of claim 15 wherein the standard deviation comprise a volume weighted standard deviation.

18. The method of claim 15 wherein the step (g) further comprises:
(g1) determining the mean of the probability density function; and wherein the step (h) further comprises:
(h1) determining a plurality of downside demand change values from the plurality of anticipated demand and realized demand value pairs, wherein a downside demand change value comprises a demand change value for which the realized demand is less than the anticipated demand;
(h2) determining a relationship between the plurality of downside demand change values and the plurality of upside demand change values;
(h3) selecting a shipping confidence factor;
(h4) determining a number of the upside demand change values that must be considered to achieve the shipping confidence factor in response to the relationship between the plurality of downside demand change values and the plurality of upside demand change values;
(h5) determining a demand variability factor from the number of upside demand change values as determined at the step (h4); and
(h6) combining the demand variability factor and the mean to determine the material buffer factor.

19. A method for determining an inventory buffer for a semiconductor fabrication process, comprising:
(a) selecting a demand sample interval;
(b) determining the buyer's anticipated demand for an integrated circuit product for the sample interval;
(c) determining the buyer's realized demand for the integrated circuit product for the sample interval;
(d) repeating the steps (b) and (c) to generate a plurality of anticipated demand and realized demand pairs;
(e) determining a plurality of demand change values from each one of the like plurality of anticipated demand and realized demand pairs;
(f) modeling the plurality of demand change values as a probability distribution function;
(g) determining statistical parameters of the probability distribution function; and
(h) determining the inventory buffer for the integrated circuit product from the statistical parameters.

20. The method of claim 19 wherein the plurality of demand change values comprise upside demand change values and downside demand change values, and wherein an upside demand change value comprises the realized demand less than the anticipated demand, and wherein a downside demand change value comprises an anticipated demand less than the realized demand, and wherein the step (f) further comprises modeling the plurality of upside demand change values as a probability density function.

21. The method of claim 19 wherein the step (h) comprises determining a first inventory buffer for a front end segment of the semiconductor fabrication process and a second inventory buffer for a back end segment of the semiconductor process.
